(19) United States
(12) Patent Application Publication
(10) Pub. No.: US 2026/0310164 A1
(43) Pub. Date: Oct. 8, 2026

(54) METHOD FOR MANUFACTURING CONCRETE FORM LINERS

(71) Applicant: Spec Formliners, Inc., Santa Ana, CA (US)

(72) Inventor: ANDREW DEERING, San Juan Capistrano, CA (US)

(73) Assignee: Spec Formliners, Inc., Santa Ana, CA (US)

(21) Appl. No.: 19/444,052

(22) Filed: Jan. 8, 2026

Related U.S. Application Data
(60) Provisional application No. 63/742,199, filed on Jan. 6, 2025.

(51) Int. Cl. G05B 19/4097; G05B 19/408

(52) U.S. Cl. CPC G05B 19/4097; G05B 19/408

(57) ABSTRACT

A new manufacturing process for the production of concrete form liners greatly streamlines manufacture over currently used methods by employing the use of a specifically designed software program. The software program allows an artist to now specify the exact dimensions of the form liner panel, the pattern used, and the artist will also be able to fully customize the textured appearance of said pattern. Once the design is complete, the artist simply sends the file off to be manufactured. This new process eliminates the time-consuming methods currently used in the art such as using modeling clay to shape each form liner mold, or through the tedious process of designing each pattern and pattern texture in CAD software.

### RELATED APPLICATION

The present application claims the benefit of priority to U.S. Provisional Patent Application Ser. No. 63/743,199 for a “Method for Manufacturing Concrete Form Liners,” filed Jan. 18, 2025. The above-mentioned application is fully incorporated herein by reference.

### FIELD OF THE INVENTION

The present invention pertains generally to a new method of manufacturing concrete form liners through the use of a new software program.

### BACKGROUND OF THE INVENTION

Form liners have been used across a multitude of different industries to add decorative features to the exterior of buildings, retaining walls, and freeway dividers. The main benefit of these devices is that they allow architects and construction workers to add a decorative feature to a surface that would otherwise appear bare.

Form liners are simple to use out in the field once they are constructed. For use, the form liners are placed on the inside of a concrete form system prior to the concrete being poured into the system. As the concrete dries, the form liner acts as a mold for the concrete to form against. This allows any design that was created by the form liner to be imprinted onto the surface of the concrete once the drying process is completed. Once the concrete has been set, all a field worker needs to do is remove the form liner and either throw away the liner, or use it for a second application at a second location.

Although form liners themselves are commonly used in the field, currently the development of the form liner itself, especially when mass producing, is still cumbersome. One method of creating form liners is for an artist to start with a plywood base that is the size of the desired pattern, and then cut the pattern into the front surface of the plywood in accordance with the specification of the pattern. Once the cutting process is complete, the artist will then fill in the cuts with modeling clay and shape the clay into the desired pattern to create a “negative” of the desired mold. To create a positive of the mold, the artist will pour liquid elastomeric polyurethane into the negative mold to create a master mold for use in the manufacturing of form liners.

Another known process incorporates the use of CAD software and CNC machining to cut out the master. At the start of the process the artist will use the CAD software to generate the required pattern and to also create the desired textured appearance. This may appear to be much simpler than the aforementioned process, but the artist will have to create each pattern and the textured effect for every single project. Further, each individual facet of the texture needs to be individually created, thus adding a tremendous amount of time to the process.

As the use of form liners continues to increase, a demand for an improved process continues to grow.

### SUMMARY OF THE INVENTION

The present invention is a new process that improves both the time and cost efficiency of creating master molds for concrete form liners. The software program that runs the process operates in a similar manner to extensions for computer-aided design (CAD) software. Once the model is complete it can be directly uploaded into a master architectural CAD file, exported to a machine shop for manufacturing of the mold itself, or both.

The process begins with a user opening the software program, where the software loads a default form liner with a default pattern displayed. A user has the ability to alter the size of the form liner, and can also select a different pattern from a number of different patterns that are stored within the program's files or a cloud service. Adding even more functionality to the software is the ability of the user to also alter the textured effects of the pattern until they achieve a desirable result. Once complete, the form liner shown by the software is ready for use within a master CAD file, or to be sent off to be manufactured.

This process greatly reduces the labor-intensive task of creating master molds for concrete liners that are currently used in the art. An artist can be easily trained to use the software, and they will no longer have to meticulously create a master through the use of modeling clay, nor will they have to draw each unique pattern in CAD to achieve a desired result. The time saved by generating the form liner within this software will enable an artist to take on more work, and to also meet tighter deadlines; thus, increasing the efficiency of the entire architectural process.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an overview of the process from being generated by the computer program, to being machined, and finally a display of an exemplary master mold;

FIG. 2 is an overview of a computer with the program installed accessing various cloud storage services for use;

FIG. 3 is a block diagram showing the software process to design and manufacture a master mold; and

FIG. 4 is a screenshot of the user interface and display shown by the software when designing a concrete form liner.

### DETAILED DESCRIPTION

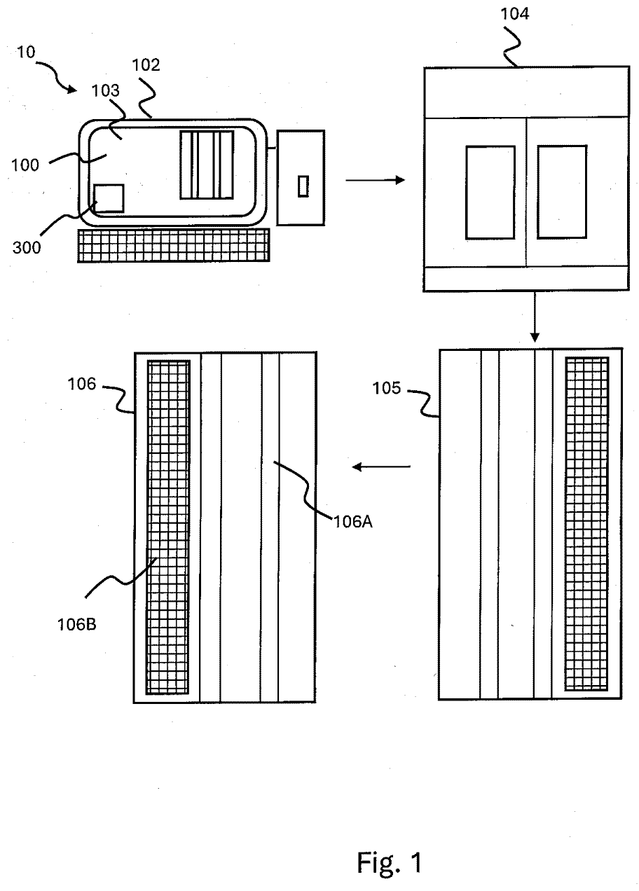

Referring initially to FIG. 1 the different components of system 10 involved throughout the different steps of the process are shown. First, computer 102 with software program 100 loaded and running on the monitor 103 is shown. The program 100 itself is able to be downloaded and installed either through an internet connection, through the use of a disc, or other media known in the art. Regardless, of how software program 100 is installed onto computer 102, a user is able to create a wide variety of different patterns to create a form liner mold 105 that is then cast to create form liner 106. Form liner 106 is shown in this figure with an exemplary fractured rib pattern 106A, which is only one of many different patterns that a user can design with.

After completing the pattern design in software program 100, a user either exports the pattern design to a master architectural CAD file, or the design is sent for manufacturing of the master form liner mold 105 through the use of computer numerical control (CNC) milling machine 104. While CNC milling machine 104 is typically used, any other manufacturing technique known in the art to achieve similar results is fully contemplated herein, including but not limited to 3-dimensional (3D) printers. The flexibility of where a user can send the completed design is due to the producing a CAD file, such as a stereolithography (STL) file recognizable by the extension “.stl,” which is used by most CAD modeling software. This allows the design for the master form liner mold 105 to be easily loaded into a different file so that it can be displayed in a master project file, or it can have a tool path generated by the software so that CNC milling machine 104 can create the design.

Once the manufacturing process is complete a user is left with a master form liner mold 105 from which they can create form liner 106. This allows a user to easily produce as many identical form liners 106 as may be necessitated for a job, or alternatively save the master mold design file until another project with the same design needs come up.

In a preferred embodiment, the material for the construction of master form liner mold 105 is elastomeric polyurethane because it can be applied to most, if not all, situations. However, in other embodiments master form liner mold 105 can be constructed out of other plastics that includes, but is not limited to, polystyrene sheets, ABS sheets, and high-density polyurethane foam.

In a preferred embodiment, once the creation of the pattern design is completed, a block bar of elastomeric polyurethane is cut to the initial size dimensions entered in by a user. Once that is completed, the elastomeric polyurethane is then loaded into CNC milling machine 104 and secured according to best practices. Then the machinist will check to ensure that the tool path that was generated based on the design pattern is ready to operate without error, and also checks that the correct drill bits are loaded into the machine. With all those steps completed, the machinist will then be able to start the program and CNC milling machine 104 will cut the pattern into the material block loaded inside the machine. What is left after CNC milling machine 104 completes the job is form liner mold 105, which serves as the master mold for the project.

If desired, using form liner mold 105, multiple form liners 106 can be made by covering the form liner mold 105 with a releasing agent and coating the form liner mold with a hardening polymer which when cured, is removed as the form liner 106.

More specifically, the present invention may be used to create a form liner that is used directly on a construction project. In this instance, the form liner is positioned and then filled with a building material, such as concrete, so that after the concrete cures and the form liner is removed, the concrete is shaped in a negative form from the form liner.

In an alternative embodiment of the present invention, a form liner mold 105 may be created. The form liner mold 105 is a mold from which multiple form liners 106 can be manufactured. This allows for one master CNC created form liner mold 105 to be used to create multiple form liners 106 through a molding process. It is to be appreciated that if a form liner mold 105 is created using the present process, then the manufactured design is a negative image of the desired form liner 106 design to accommodate the molding process.

The process of designing the pattern 106A in software program 100 such that the .stl file can be easily sent to CNC milling machine 104 saves a tremendous amount of time in the design process for any artist. The patterns 106A themselves are preloaded into the program, eliminating the need to create individual CAD files for each new job unless there is a unique pattern need. If this is the case, then the user can create and save the new design to the pattern library for subsequent use at a later date.

The use of CNC milling machine 104 significantly cuts down the time spent on the manufacturing of a master mold for form liner 106. The manufacturing process itself is automated and most guess work will be eliminated from the project. The use of CNC milling machine 104 also eliminates the need for artists to use modeling clay in the design and manufacturing process. All that is needed is to ensure that the master mold is designed according to the request project specs, export the CAD generated manufacturing file so that a tool path can be generated in a separate program, and then send it out for manufacture.

Due to the simplicity of the process, software program 100 is capable of creating form liner molds that can be easily used to produce a wide variety of different form liners. The different form liners capable of being produced range from building facades, freeway retaining walls, and to artistic landscape elements. Additionally, through the use of durable materials like elastomeric polyurethane, the finished form liners are incredibly durable and easy to work with; ensuring a high-quality pattern is left behind by the form liner. Moreover, the file produced by software program 100 allows the form liner to be reproduced at will, such as if the form liner is damaged or lost.

It is to be appreciated that in construction projects requiring a large number of panels, the form liner mold 105 can be reused to create multiple form liners 106, it is also capable of directly using the form liner mold 105 as the form liner 106 thereby eliminating the molding steps to create the form liner. Essentially, when molding a form liner 106 from a form liner mold 105, the design of the form liner mold 105 would constitute a negative impression of the ultimate form liner 106. On the other hand, it is possible using the present invention to form a single or multiple form liner 106 directly through the manufacturing process. This method, however, may be more expensive to produce given that each form liner 106 would be machined or printed, and not duplicated from a master mold 105.

While form liner 106 is shown with a fractured rib pattern 106A, there are a number of different patterns that can be loaded into a project. Some other patterns include brick, stone, or simply blocks. This feature provides a tremendous amount of flexibility to an artist using software program 100. In addition to having a number of different default patterns available for use, an artist can also create their own custom pattern in a CAD software and save that new pattern into the pattern database for subsequent use at a later date.

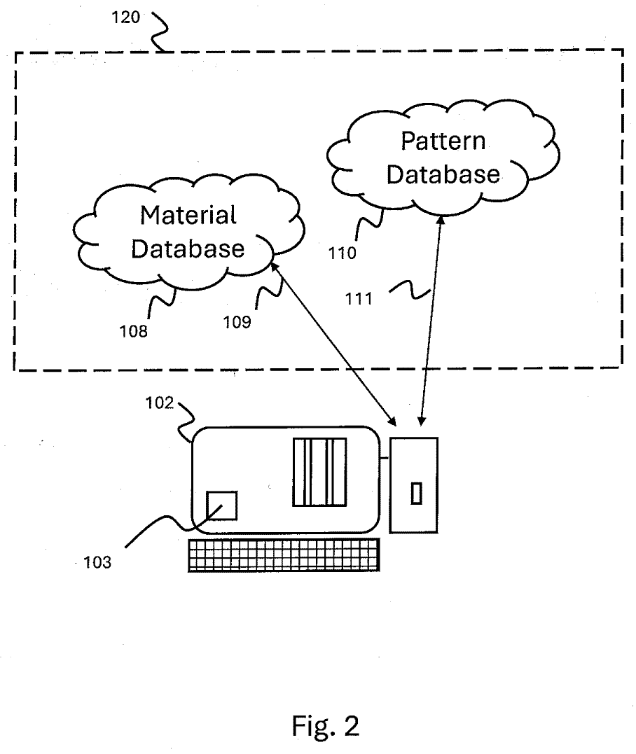

Referring now to FIG. 2, an alternative preferred embodiment of the present invention is shown. In the previously described embodiment, pattern database 110 and material database 108 are installed onto computer 102 simultaneously with software program 100. In the shown alternative embodiment, the two different databases are instead saved on a cloud server 120 that computer 102 is able to access after software program 100 is installed.

Computer 102 is able to access material database 108 and pattern database 110 via bidirectional communication links 109 and 111, respectively. Further, these two different links 109 and 111 are able to connect to their respective cloud servers 120 either through a wireless or wired internet connection. This allows for the aggregation of both the material database 108 and pattern database 110 for file sharing and archive, as well as providing a market opportunity for designing and selling key patterns or material compositions for use by others.

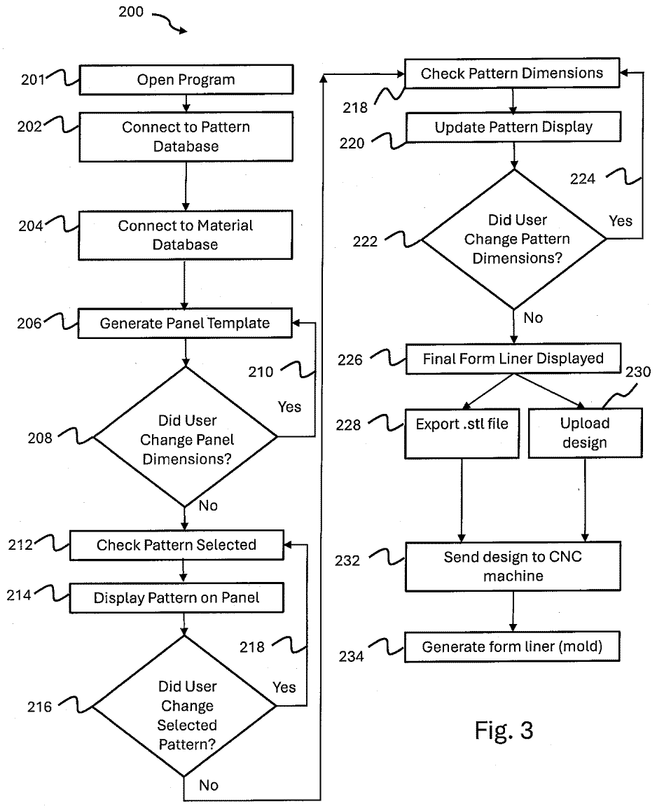

Referring now to FIG. 3, a block diagram of the steps of a preferred embodiment of a method for manufacturing concrete form liners is shown and generally designated 200. It is important to note that while the process 200 is discussed in linearly, the description is not meant to be a limiting one. In a preferred embodiment the different dimensions, patterns, and pattern dimensions can be changed at any given time and the software will update the appearance of form liner mold 105 accordingly.

In step 201, the program is opened by a user. Immediately once the program is opened the software program 100 will, simultaneously or in any combination of priority, go through steps 202 through 206. Specific to step 202, software program 100 will connect to the pattern database 110 where all of the predesigned patterns are uploaded. As mentioned during the discussion of FIG. 2, the pattern database 110 can be installed directly onto computer 102, or computer 102 can access the pattern database 110 through a connection to a cloud server 120. In step 204, software program 100 will also connect to the material database, which is either another library installed onto computer 102, or accessed via a cloud storage system 120. For step 206, software program 206 will generate a default panel template that is predetermined, or may be a design template from a prior design session.

Step 208 is where loop function 210 of software program 100 occurs. Step 208 asks the program to check whether or not a user has changed the dimensions of the preloaded panel template. If the answer is no, the program will proceed to step 212; however, if the answer is yes, the program will route back to step 206 via path 210 and generate an updated panel display based on the changed dimensions. This loop 210 will continue until no further changes are made to the panel dimensions.

At step 212 software program 100 will check to see what pattern is currently selected, and once that determination is made then the pattern is displayed onto the panel at step 214. Step 216 is another loop function for software program 100, and the program checks whether or not the user has changed the selected pattern. If the answer is no, then software program 100 will proceed to step 218. But, if the answer is yes, then software program 100 will loop back to step 212 to check the new pattern that was selected and then subsequently display the new pattern. This loop 218 will continue until no further changes are made to the panel pattern.

Step 218 through step 226 generally involves a user having the ability to change the pattern dimensions within software 100 after the pattern selection in steps 212 to 216. Initially at step 218, software program 100 checks the pattern dimensions and then updates the pattern display at step 220 based on the pattern dimensions. Next at step 222, the final loop function of software program 100 is executed and the software will determine whether or not the pattern dimensions were changed. If the answer is no, then software program 100 will proceed to step 226 and display the final form liner mold design. However, if the answer I step 222 is yes and the pattern dimensions were changed, then software program 100 will loop back to step 218 via path 224 and check the new pattern dimensions before subsequently displaying those new dimensions in step 220.

As mentioned earlier, step 226 involves the display of the final form liner that was designed by a user. Once a user is satisfied with the design of form liner 106, then they can instruct software program 100 to proceed to step 228 and have the .stl file generated exported for use with different software as needed. The use of an .stl file is exemplary as the preferred format in preferred embodiments, however, other files supported by CNC machines or CAD software are supported in preferred embodiments, and can be generated in place of, or in addition to, an .stl file in step 228.

Rather than generating the .stl file, the user may directly upload the design to a third-party service, as illustrated by step 230. In most cases, this involves exporting the design to an .stl file or other supported file format, and sending that file via the internet or other network service to the third-party service; however, in preferred embodiments, this file export is handled by the software in a manner transparent to the user. Step 230 is particularly useful when the artist or designer is not co-located with the operator of the CNC milling machine or other equipment that will manufacture the concrete form liner.

In step 232, the design—generally in the form of an .stl file or other supported design file, as discussed above—is sent to the manufacturing equipment, which is a CNC milling machine in typical circumstances. The manufacturing equipment is then used to manufacture the form liner mold 105, as illustrated by step 234. Once the form liner mold 105 is completed, it may be used as a base to form a plurality of form liners 106.

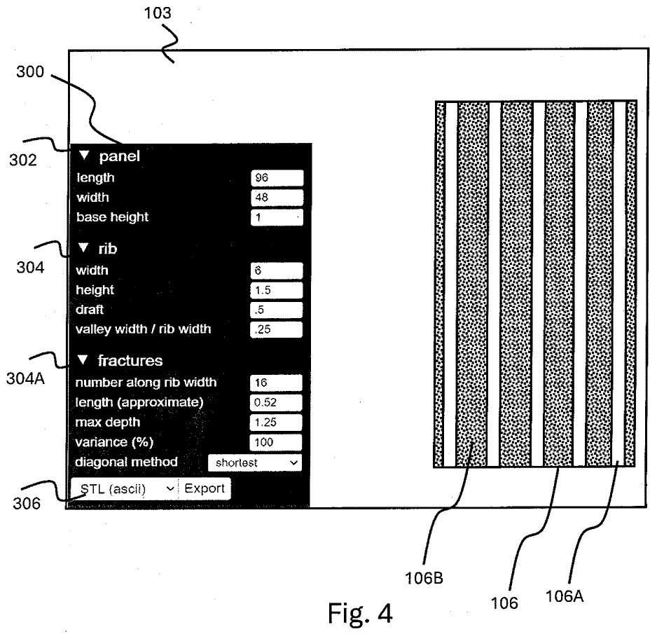

Referring now to FIG. 4, a screenshot of the software user interface is shown. In this embodiment, the form liner 106 is shown with a fracture rib pattern 106A on the form liner 106 surface. Form liner 106 is typically shown on the right side of the screen as shown, but it can be moved around by the user by clicking onto the object.

User interface (UI) 300 is shown in the bottom left corner of the screen 103. As shown UI 300 allows the user to enter in a wide variety of different variables to customize the design of form liner 106. At the top of UI 300 is pattern dimension box 302 which allows the user to alter the dimensions of form liner 106 depending on the needs of the job. The default size is shown, 48″×96″, but those values can be changed to any value.

Next, below panel dimension box 302 is the pattern dimension box 304. In a nonlimiting example, the current pattern of ribs 106A and fractures 106B displayed on form liner 106 is the fractured rib pattern. Alternatively, the features of the specific fracture for the design can be modified through menu 304A This pattern is uploaded from the pattern database 110 that is part of the software, or alternatively can be uploaded from a cloud service 120 that stores the default patterns and the accompanying dimensions. Allowing a user to customize both the rib portion and the fracture portion in pattern dimension box 304 creates a wide range of possible designs that can be generated.

Improving the efficiency is that any dimension, regardless of whether it is located inside panel dimension box 302 or pattern dimension box 304, can be changed at the discretion of the user and the software will automatically update the display 103. This allows a user to see the impact of different design changes at a moment's notice and eliminates the risk of causing a significant amount of work which happens when creating a master mold from modeling clay, or when designing each form liner 106 in CAD alone.

Another feature of the displayed form liner 106 is that the user is able to rotate the model within the program. The software is able to do this by taking into account the edge conditions that are currently displayed by form liner 106. This allows the software to correctly display form liner 106 with the pattern projected onto it regardless of what position a user may rotate the object to. An additional benefit of this feature for software program 100 is that the edge conditions are also imported with the file into CAD software which results in a user being able to make duplicates of form liner 106 within the master architectural file and placing each form liner 106 made side by side.

The final portion of the software display at the very bottom left corner of the screen is export tab 306. The default file format is .stl, because of the universal applicability it will have across different CAD software and CNC machines. However, any other file type that will achieve similar results and are known in the art are fully contemplated herein.

While there have been shown what are presently considered to be preferred embodiments of the present invention, it will be apparent to those skilled in the art that various changes and modifications can be made herein without departing from the scope and spirit of the invention.

I claim:

1. A method for manufacturing concrete form liners, comprising:
providing a system having a pattern database containing at least one pattern and a material database containing at least one material;
generating, by the system, a panel template and selecting a pattern from the pattern database;
selecting a material from the material database;
generating an export file corresponding to the panel template, the selected pattern, and the selected material;
transmitting the export file to a manufacturing device;
creating a master mold based on the export file; and
using the master mold to create a concrete form liner.

2. The method of claim 1, wherein the pattern database includes a plurality of architectural surface patterns selectable by a user.

3. The method of claim 1, wherein the material database includes at least one of polyurethane, silicone, rubber, elastomeric polymers, plastics, composites, or combinations thereof.

4. The method of claim 1, wherein generating the panel template includes defining at least one of panel dimensions, thickness, edge geometry, relief depth, or mounting features.

5. The method of claim 1, wherein the export file comprises a CAD file, CAM file, CNC toolpath file, STL file, or additive manufacturing file.

6. The method of claim 1, wherein transmitting the export file includes electronically transmitting the export file over a network to the manufacturing device.

7. The method of claim 1, wherein the manufacturing device comprises a CNC milling machine, a 3-axis or 5-axis machining center, a 3D printer, or a hybrid subtractive-additive manufacturing device.

8. The method of claim 1, wherein creating the master mold includes machining, milling, carving, engraving, or additive fabrication based on the export file.

9. The method of claim 1, wherein the master mold is formed from at least one of foam, wood, metal, polymer, composite, or resin materials.

10. The method of claim 1, wherein using the master mold to create the form liner includes casting, molding, or forming the selected material against the master mold.

11. The method of claim 1, wherein the concrete form liner is configured to impart a textured or patterned surface onto cast concrete.

12. The method of claim 1, further comprising modifying the selected pattern or material prior to generating the export file.

13. The method of claim 1, wherein the system allows automated compatibility verification between the selected pattern and the selected material.

14. The method of claim 1, wherein the panel template and pattern are generated parametrically based on user input.

15. A computer-implemented method for manufacturing concrete form liners, comprising:
accessing a pattern database and a material database;
generating a digital representation of a form liner panel including a selected pattern and material;
exporting manufacturing data corresponding to the digital representation; and
manufacturing a master mold from the manufacturing data for producing concrete form liners.

16. A concrete form liner produced by a process comprising:
generating a panel template using a system having a pattern database and a material database;
selecting a pattern and a material from the respective databases;
generating and transmitting an export file to a manufacturing device;
creating a master mold based on the export file; and
forming the concrete form liner using the master mold.

17. The concrete form liner of claim 16, wherein the liner includes a patterned surface corresponding to the selected pattern from the pattern database.

18. The concrete form liner of claim 16, wherein the liner is formed from polyurethane, silicone, rubber, or an elastomeric polymer.

19. The concrete form liner of claim 16, wherein the liner is configured for repeated use in concrete casting operations.

20. The concrete form liner of claim 16, wherein the liner includes a three-dimensional relief pattern imparted to cast concrete.
